(19) United States
(12) Patent Application Publication
(10) Pub. No.: US 2008/0094414 A1
(43) Pub. Date: Apr. 24, 2008

(54) Multimedia Video Generation System

(76) Inventors: San-Wei Lin, Luodong Township (TW); Peng-Wei Chen, Sijhih City (TW); Chen-Hsiu Weng, Jhonghe City (TW); Yon-Fon Kuo, Taichung City (TW); Tsai-Yen Li, Taipei City (TW); Wen-Hung Liao, Taipei City (TW)

Correspondence Address: LAW OFFICES OF LAI AND ASSOCIATES, P.C., 5800 RANCHESTER STE 200, HOUSTON, TX, 77036, US

(21) Appl. No.: 11/623,712

(22) Filed: Jan. 16, 2007

(30) Foreign Application Priority Data
Oct. 20, 2006 (TW) 095218615

(51) Int. Cl. G09G 5/00

(52) U.S. Cl. 345/629

(57) ABSTRACT

A multimedia video generation system is disclosed. The system comprises a receiving unit, a characteristic recognition unit, an object providing unit and a video synthesis unit. The receiving unit is for receiving a video consisted of a plurality of frames. The characteristic recognition unit is for recognizing an attribute parameter of a characteristic in these frames respectively. The object providing unit is for providing a first object and a second object based on the video and the characteristic respectively. The video synthesis unit is for synthesizing the video, the first object and the second object to generate a synthesized video.

### FIELD OF THE INVENTION

The present invention relates to a multimedia video generation system, and more particularly to a multimedia video generation system that synthesizes a video and a tracked object.

### BACKGROUND OF THE INVENTION

As imaging devices including digital cameras, digital camcorders, webcams and photographing mobile phones become increasingly low-priced and popular, consumers have higher demand on applications of imaging devices, and the integration of home computers and consumer electronic products becomes a significant trend. Users start creating, adding and reforming innovations of digital contents. However, operating interfaces of the present video editing software are too complicated, and users usually give up easily before learning how to operate and use them. In addition, the common imaging effects viewed in television contents require professional skills and expensive software and hardware, and thus users seldom can create digital contents on their own.

In view of the aforementioned shortcomings of the prior art, the inventor of the present invention based on years of experience in the related industry develops a multimedia video generation system to overcome the shortcomings of the prior art.

### SUMMARY OF THE INVENTION

Therefore, it is a primary objective of the present invention is to provide a multimedia video generation system that comes with a user-friendly natural multimedia video generation interface.

The present invention automatically recognizes and tracks a characteristic such as a face characteristic of an image in a video and adds an object to the characteristic and finally generates a synthesized video for displaying an object that moves according to the characteristic of the image, and allows users to create digital contents by a low cost.

To achieve the foregoing objective, the present invention provides a multimedia video generation system that comprises a receiving apparatus, a characteristic recognition unit, an object providing unit and a video synthesis unit. The receiving apparatus is for receiving a video consisted of a plurality of frames. The characteristic recognition unit is for recognizing an attribute parameter of a characteristic in these frames respectively. The object providing unit is for providing a first object and a second object based on the video and the characteristic respectively. The video synthesis unit is for synthesizing the video, the first object and the second object to generate a synthesized video.

To make it easier for our examiner to understand the objective of the invention, its structure, innovative features, and performance, we use a preferred embodiment together with the attached drawings for the detailed description of the invention.

### BRIEF DESCRIPTION OF THE DRAWINGS

FIG. 1 is a schematic view of a multimedia video generation system in accordance with a preferred embodiment of the present invention;

FIG. 2A shows a frame of a synthesized video in accordance with the present invention;

FIG. 2B shows another frame of a synthesized video in accordance with the present invention;

FIG. 3 is a flow chart of an operating method of a multimedia video generation system in accordance with the present invention.

### DETAILED DESCRIPTION OF THE PREFERRED EMBODIMENTS

In the following figures, same numerals are provided for the reference of same elements in the following preferred embodiment to make the illustration of a multimedia video generation system in accordance with the preferred embodiment of the present invention easier to understand.

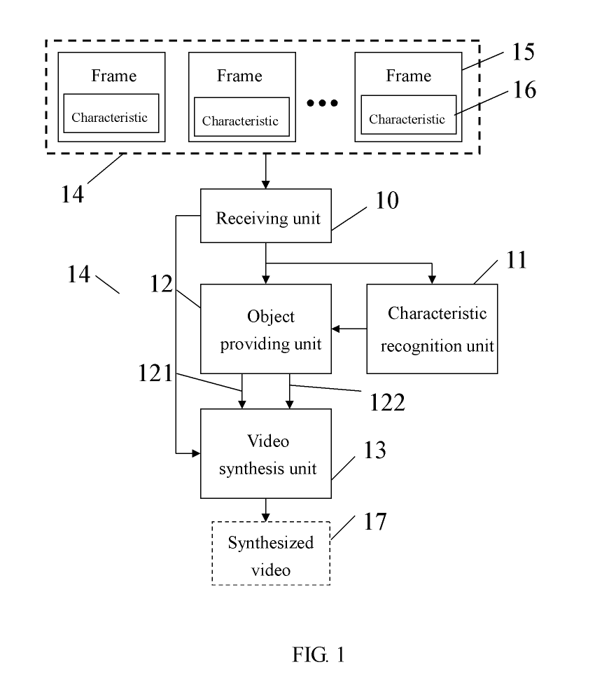

Referring to FIG. 1 for a schematic view of a multimedia video generation system in accordance with a preferred embodiment of the present invention, the multimedia video generation system 1 comprises a receiving apparatus 10, a characteristic recognition unit 11, an object providing unit 12 and a video synthesis unit 13. The receiving apparatus 10 is for receiving a video 14 consisted of a plurality of frames 15. The receiving apparatus 10 includes a decoder, if needed, for decoding a received encoded video to obtain the frame 15. The encoded video can be an encoded video content of MPEG1, MPEG2, MPEG4 or other video format.

The characteristic recognition unit 11 is provided for recognizing a characteristic 16 in the frames 15 to obtain an attribute parameter of the characteristic 16, such as detecting a face image characteristic or a face expression image characteristic in the frame, and the attribute parameter includes a position, a size or a rotation angle of the characteristic. The characteristic recognition unit 11 carries out a characteristic recognition and a characteristic matching to obtain the position of the characteristic and carries out a tracking, wherein the characteristic recognition may consider capturing a low-level characteristic (such as feature points) or a high-level characteristic (including a face characteristic such as an eye, a mouth or a nose) based on the nature of application. The method for matching a characteristic includes an implicit algorithm and an explicit algorithm, and the explicit characteristic matching method searches a one-to-one correspondence among the characteristics, and the implicit characteristic matching method uses a parameter or a transformation to represent the relation between the characteristics of two successive frames. With the foregoing technological combination, characteristics can be detected according to different natures. For example, a combination of explicit algorithm and high-level characteristic can be used for analyzing face expression, and a combination of implicit algorithm and high-level characteristic can be used for recognizing and positioning a sense organ of a face. The characteristic recognition technology is a prior art, and thus will not be described here.

The object providing unit 12 is for providing a first object 121 and a second object 122 according to the video 14 and the characteristic 16. The displaying position of the first object corresponds to the frame 15, and the displaying position of the second object 122 corresponds to the position of the characteristic 16. The object providing unit 12 can provide a first object and a second object according to a pre-selected mode, if needed. The objects are selected from a medium material which includes a pattern, an image or an audio, and the pre-selected mode could be a festival theme such as New Year, Christmas, Mid-Autumn Festival or a cartoon character such as Superman, Spiderman, King of Monkey or a monster. Each theme includes a media material corresponding to the first object and a medium material corresponding to the second object. If the pre-selected mode is Mid-Autumn Festival, then the medium material corresponding to the first object could be a pattern of moon and cloud displayable around the frame of the video 14, and the second object could be a pattern of Moon Goddess's hair ornament displayable on a human face in the frame and moved together with the face to change the position, size or rotation angle of the display.

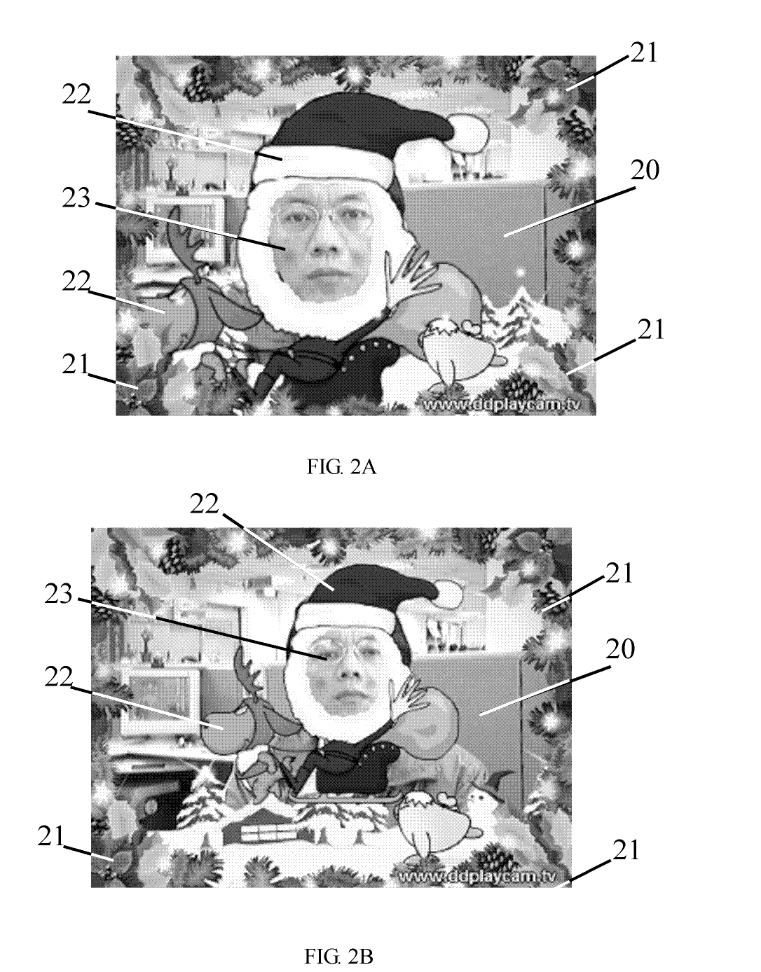

The video synthesis unit 13 synthesizes the video 14 with the first object 121 or the second object 122 to generate a synthesized video 17. Referring to FIGS. 2A and 2B for schematic views of a frame of a synthesized video, the multimedia video generation system as shown in FIG. 2A is provided for receiving a video of a photographed person's face 23 and producing a first object and a second object according to a Christmas related theme, and the first object is a pattern 21 displayed around the frame 20 and the pattern 21 includes a Christmas tree, a pine cone and a snow scene, and the second object is a pattern 22 displayed around a face 23 and the second pattern 22 includes a Christmas hat, a beard, a Santa Claus waving his hands, and a Rudolph reindeer, etc. Referring to FIG. 2B for a frame of the synthesized video taken at other time, the photographed person is moving to the right and the rear, and thus the position and size of the face image are changed. The characteristic recognition unit 11 carries out a face recognition and a face tracking to obtain the position, size and rotation angle of a face of a photographed person, and thus the multimedia video generation system can adjust the position and size of the pattern 22 to fit the photographed person's face, and simulate the photographed person to be moved together with the pattern 22a, so as to achieve the effect of integrating the photographed person and the simulated pattern.

Preferably, the multimedia video generation system utilizes a processor to execute a program code by software.

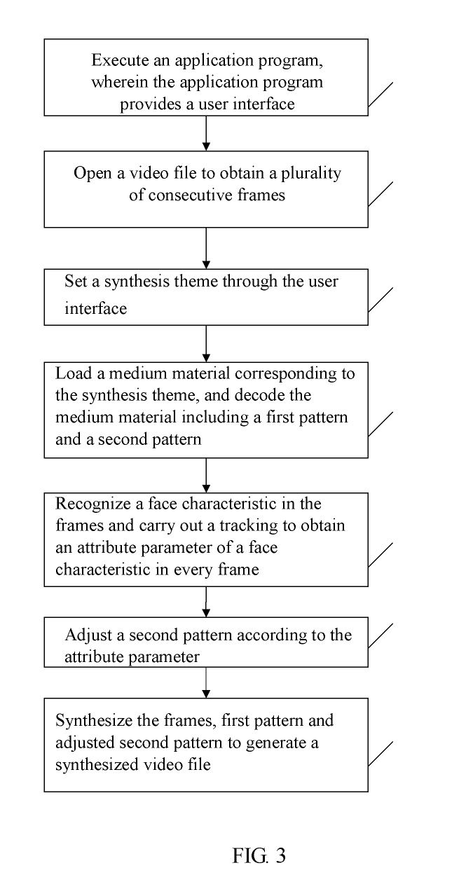

Referring to FIG. 3 for a flow chart of an operating method of the multimedia video generation system in accordance with the present invention, the operating method comprises the steps of:

Step 30: executing an application program, wherein the application program provides a user interface;

Step 31: opening a video file to obtain a plurality of consecutive frames, and displaying the frames through the user interface;

Step 32: setting a synthesis theme through the user interface;

Step 33: loading a medium material corresponding to the synthesis theme, and decoding the medium material, wherein the medium material includes a first pattern and a second pattern;

Step 34: recognizing a face characteristic in the plurality of frames and carrying out a tracking to obtain an attribute parameter such as a position, a size and a rotation angle of a face characteristic in every frame;

Step 35: adjusting a second pattern according to the attribute parameter; and

Step 36: synthesizing the frames, first pattern and adjusted second pattern to generate a synthesized video file.

If the video file is an encoded video file when Step 31 is carried out, then the encoded video file will obtain a plurality of consecutive frames by the decoding step. In addition, Step 31 further includes selecting a desired processing frame through the user interface, so that users need not to wait for editing after the synthesized video file is generated.

Before Step 36 is carried out, the method further includes a preview of the synthesis result. Since the synthesized video file requires more computations and longer computing time, the preview function lets users view the synthesis ahead of time to determine whether or not the synthesis result can meet a user's expectation; if yes, then carry out Step 36, or else return to Step 32.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A multimedia video generation system, comprising:
a receiving unit, for receiving a video consisted of a plurality of frames;
a characteristic recognition unit, for recognizing a characteristic separately in an attribute parameter of said frames;
an object providing unit, for providing a first object and a second object respectively according to said video and said characteristic; and
a video synthesis unit, for synthesizing said video with said first object or said second object to generate a synthesized video.

2. The multimedia video generation system of claim 1, wherein said object providing unit provides said first object and said second object according to a pre-selected mode.

3. The multimedia video generation system of claim 1, wherein said first object and said second object are selected from a medium material, and said medium material is a pattern, an animation, a video data or an audio data.

4. The multimedia video generation system of claim 1, wherein said characteristic is a face image characteristic or a face expression image characteristic.

5. The multimedia video generation system of claim 1, wherein said characteristic recognition unit further includes tracking a change of attribute parameter of said characteristic at said frames.

6. The multimedia video generation system of claim 1, wherein said receiving apparatus further includes receiving an encoded video for decoding said encoded video to obtain a frame of said encoded video.

7. The multimedia video generation system of claim 1, wherein said attribute parameter includes a position, a size or a rotation angle.

8. The multimedia video generation system of claim 1, wherein said first object and said second object are selected from a medium material, and said medium material is a pattern, an animation, a video data or an audio data.

9. A storage apparatus, for storing a plurality of programs read and processed by a media processor and said media processor bases on said programs to execute a procedure comprising the steps of:
inputting a video, and said video is consisted of a plurality of frames;
providing a first medium material according to said video;
recognizing a characteristic at a position of said frames, and tracking a change of said characteristic in said frames;
providing a second medium material according to said characteristic; and
synthesizing said video, said first medium material and said medium material to generate a synthesized video.

10. The storage apparatus for storing a plurality of programs read and processed by a media processor as recited in claim 9, wherein said step of inputting a video further comprises the steps of:
inputting an encoded video; and
decoding said encoded video to obtain said frames.

11. The storage apparatus for storing a plurality of programs read and processed by a media processor as recited in claim 9, wherein said step of providing a first medium material further comprises the steps of:
loading said first medium material; and
decoding said first medium material.

12. The storage apparatus for storing a plurality of programs read and processed by a media processor as recited in claim 9, wherein said step of providing a second medium material further comprises the steps of:
loading said second medium material; and
decoding said second medium material.

13. The storage apparatus for storing a plurality of programs read and processed by a media processor as recited in claim 9, wherein said characteristic is a face image characteristic or a face expression image characteristic.
